(19) United States
(12) Patent Application Publication
(10) Pub. No.: US 2014/0118185 A1
(43) Pub. Date: May 1, 2014

(54) LEVEL MEASUREMENT INSTRUMENT FIDUCIAL DIAGNOSTICS

(71) Applicant: Magnetrol International, Incorporated, Aurora, IL (US)

(72) Inventors: Michael J. Linden, Aurora, IL (US); Timothy S. Sussman, Bolingbrook, IL (US)

(73) Assignee: Magnetrol International, Incorporated, Aurora, IL (US)

(21) Appl. No.: 14/059,752

(22) Filed: Oct. 22, 2013

Related U.S. Application Data
(60) Provisional application No. 61/720,607, filed on Oct. 31, 2012.

(51) Int. Cl. G01F 23/284

(52) U.S. Cl. CPC G01F 23/284
USPC 342/124

(57) ABSTRACT

A process measurement instrument including a fiducial and adapted for detection of the fiducial. The instrument comprises an interface circuit comprising a drive circuit for transmitting a pulse signal at the fiducial and at a target of interest and a receive circuit receiving reflected echoes of the pulse signal and developing an analog receive signal representative of the reflected echoes. A signal processing circuit is operatively coupled to the interface circuit for receiving the analog receive signal and determining characteristics of reflected echoes for the fiducial and the target of interest. The controller is operatively coupled to the signal processing circuit and includes a diagnostic routine responsive to the characteristics of the reflected echo for the fiducial in determining if a fiducial error condition exists.

### CROSS-REFERENCE TO RELATED APPLICATIONS

This application claims priority of provisional application No. 61/720,607, filed Oct. 31, 2012.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to process control instruments, and more particularly, to a level measurement instrument using improved fiducial diagnostics.

### BACKGROUND

Process control systems require the accurate measurement of process variables. Typically, a primary element senses the value of a process variable and a transmitter develops an output having a value that varies as a function of the process variable. For example, a level transmitter includes a primary element for sensing level and a circuit for developing an electrical signal proportional to sensed level.

Knowledge of level in industrial process tanks or vessels has long been required for safe and cost-effective operation of plants. Many technologies exist for making level measurements. These include buoyancy, capacitance, ultrasonic and microwave radar, to name a few. Some level measurement instruments measure the distance from a known location to a material surface. Particularly, distance measuring devices including those employing guided wave radar and through air radar technology often make use of a reference signal, referred to as a fiducial. The fiducial is a known location, typically in the instrument housing or at the top of a probe or antenna. The location and presence of the fiducial must be determined accurately in order for the distance measurement to be accurate. The distance to the surface of interest is determined by the apparent difference in time of signals between the fiducial and the surface of interest.

If there is an error in measuring the location of the fiducial, it is important to provide an indication that there is a fiducial error. Such an error could occur if the probe becomes disconnected or the instrument measures the location of the fiducial different from where it should be. Any such errors will result in inaccurate measurement of difference, such as level. Thus, it is useful to provide diagnostic information relating to the fiducial.

The present invention is directed to solving one or more of the problems discussed above in a novel and simple manner.

### SUMMARY

As described herein, a measurement instrument determines diagnostics information for a fiducial or other signal.

There is disclosed herein in accordance with one aspect a process measurement instrument including a fiducial and adapted for detection of the fiducial. The instrument comprises an interface circuit comprising a drive circuit for transmitting a pulse signal at the fiducial and at a target of interest and a receive circuit receiving reflected echoes of the pulse signal and developing an analog receive signal representative of the reflected echoes. A signal processing circuit is operatively coupled to the interface circuit for receiving the analog receive signal and determining characteristics of reflected echoes for the fiducial and the target of interest. The controller is operatively coupled to the signal processing circuit and includes a diagnostic routine responsive to the characteristics of the reflected echo for the fiducial in determining if a fiducial error condition exists.

It is a feature that the interface circuit is operatively coupled to a probe defining a transmission line.

It is another feature that the interface circuit is operatively coupled to a probe defining an antenna.

It is a further feature that the controller comprises a programmed processor.

It is another feature that the diagnostic routine is operable to determine if the location of the reflected echo for the fiducial is outside of an expected range. The location of the reflected echo for the fiducial may be determined by averaging leading and trailing edges of the reflected echo for the fiducial.

It is yet another feature that the controller determines if the reflected echo for the fiducial is not received in a receive window and responsive thereto includes a no fiducial diagnostic.

It is an additional feature that the diagnostic routine is operable to determine if amplitude of the reflected echo for the fiducial is outside of an expected range. The diagnostic routine may be operable to determine if amplitude of the reflected echo for the fiducial is above an expected range to indicate that a probe is disconnected.

It is yet another feature that the controller is responsive to a determination that a fiducial error does not exist to determine a time value between the reflected echo for the fiducial and the reflected echo for the target of interest to determine a distance value.

There is disclosed in accordance with another aspect a guided wave radar level measurement instrument comprising a probe for extending into a process vessel. The probe includes a fiducial. An interface circuit is electrically connected to the probe and comprises a drive circuit for transmitting a pulse signal at the fiducial and at a target of interest and a receive circuit receiving reflected echoes of the pulse signal and developing an analog receive signal representative of the reflected echoes. A signal processing circuit is operatively coupled to the interface circuit for receiving the analog receive signal and determining characteristics of reflected echoes for the fiducial and the target of interest. A controller is operatively coupled to the signal processing circuit and includes a diagnostic routine responsive to the characteristics of the reflected echo for the fiducial in determining if a fiducial error condition exists.

Further features and advantages will be readily apparent from the following specification and drawings.

### BRIEF DESCRIPTION OF THE DRAWINGS

FIG. 1 is an elevation view of a guided wave radar instrument with fiducial detection in accordance with the invention;

FIG. 2 is a block diagram of the instrument of FIG. 1;

FIG. 3 is a curve illustrating single edge fiducial detection;

FIG. 4 is a curve illustrating dual edge fiducial detection in accordance with the invention;

FIG. 5 is an electrical schematic for a signal processing circuit for detecting leading and trailing edges of echo pulses;

FIG. 6 is a timing diagram illustrating curves associated with the probe of FIG. 1; and

FIG. 7 is a flow diagram illustrating a fiducial diagnostic routine implemented in the controller of FIG. 2.

### DETAILED DESCRIPTION

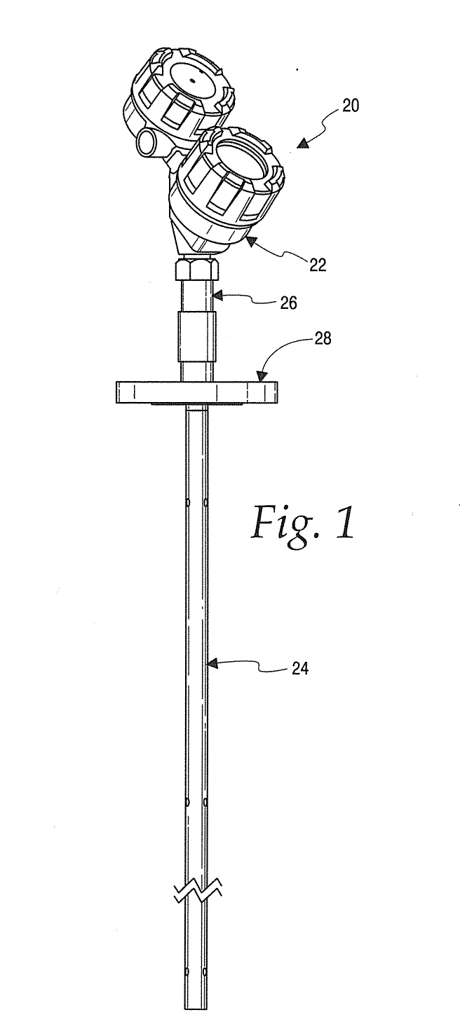

Referring to FIG. 1, a process instrument 20 is illustrated. The process instrument 20 uses pulsed radar in conjunction with equivalent time sampling (ETS) and ultra-wide band (UWB) transceivers for measuring level using time domain reflectometry (TDR). Particularly, the instrument 20 uses guided wave radar for sensing level. While the embodiment described herein relates to a guided wave radar level sensing apparatus, various aspects of the invention may be used with other types of process instruments for measuring various process parameters such as, for example, through air radar.

The process instrument 20 includes a control housing 22, a probe 24, and a connector 26 for connecting the probe 24 to the housing 22. The probe 24 is adapted for mounting a process vessel using a flange 28. The housing 22 is then secured to the probe 24 as by threading the connector 26 to the probe 24 and also to the housing 22. The probe 24 comprises a high frequency transmission line which, when placed in a fluid, can be used to measure level of the fluid. Particularly, the probe 24 is controlled by a controller 30, described below, in the housing 22 for determining level in the vessel.

As described more particularly below, the controller 30 generates and transmits pulses on the probe 24. A reflected signal is developed off any impedance changes, such as the liquid surface of the material being measured. A small amount of energy may continue down the probe 24. The probe 24 typically includes a fiducial comprising an impedance change at a known location, such as at the connector 26 to the probe 24. The controller 30 is operable to determine the time distance of reflected echoes from the fiducial to the liquid surface, being the surface of interest, to determine level.

While the embodiment described herein relates to a guided wave radar instrument, the principles used could be applied to other instruments, such as through air radar technology. With through air radar the probe is actually an antenna spaced from the surface of interest, as is known. The fiducial is created from measuring the impedance mismatch of the electronic circuitry's launcher to the antenna and the antenna itself. The use of a fiducial for generating a reference signal is known in connection with level measurement. The present invention is not directed to the use of a fiducial per se, but rather to a diagnostic routine to indicate the existence of fiducial error conditions.

Guided wave radar, and similarly pulse burst radar for through air measurement, combines TDR, ETS and low power circuitry. TDR uses pulses of electromagnetic (EM) energy to measure distanced or levels. When a pulse reaches a dielectric discontinuity then a part of the energy is reflected. The greater the dielectric difference, the greater the amplitude of the reflection. In the measurement instrument 20, the probe 24 comprises a transmission line with a characteristic impedance in air. When part of the probe 24 is immersed in a material other than air, there is lower impedance due to the increase in the dielectric. When the EM pulse is sent down the probe, it meets the dielectric discontinuity and a reflection is generated.

ETS is used to measure the high speed, low power EM energy. The high speed EM energy (1000 feet/microsecond) is difficult to measure over short distances and at the resolution required in the process industry. ETS captures the EM signals in real time (nanoseconds) and reconstructs them in equivalent time (milliseconds), which is much easier to measure. ETS is accomplished by scanning the transmission line to collect thousands of samples. Approximately five scans are taken per second.

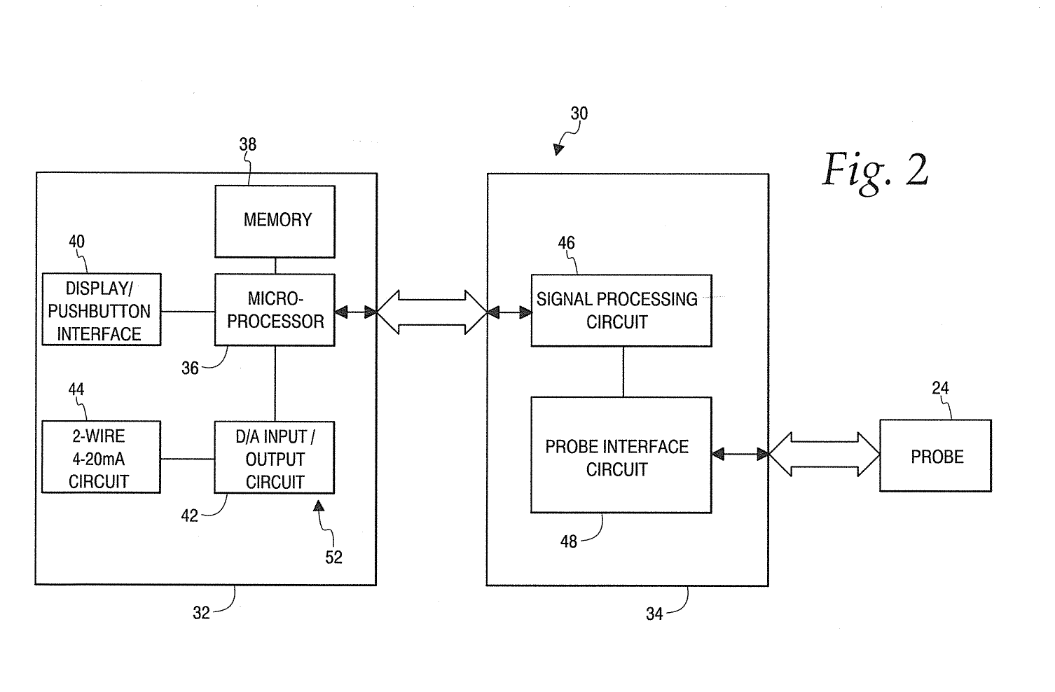

Referring to FIG. 2, the electronic circuitry mounted in the housing 22 of FIG. 1 is illustrated in block diagram form as an exemplary controller 30 connected to the probe 24. As will be apparent, the probe 24 could be used with other controller designs. The controller 30 includes a digital circuit 32 and an analog circuit 34. The digital circuit 32 includes a microprocessor 36 connected to a suitable memory 38 (the combination forming a computer) and a display/push button interface 40. The display/push button interface 40 is used for entering parameters with a keypad and displaying user and status information. The memory 38 comprises both non-volatile memory for storing programs and calibration parameters, as well as volatile memory used during level measurement. The microprocessor 36 is also connected to a digital to analog input/output circuit 42 which is in turn connected to a two-wire circuit 44 for connecting to a remote power source. Particularly, the two-wire circuit 44 utilizes loop control and power circuitry which is well known and commonly used in process instrumentation. The two-wire circuit 44 controls the current on the two-wire line in the range of 4-20 mA which represents level or other characteristics measured by the probe 24. The two-wire circuit 44 also supports digital communications such as HART, which is well known.

The microprocessor 36 is also connected to a signal processing circuit 46 of the analog circuit 34. The signal processing circuit 46 is in turn connected via a probe interface circuit 48 to the probe 24. The probe interface circuit 48 includes an ETS circuit which converts real time signals to equivalent time signals, as discussed above. The signal processing circuit 46 processes the ETS signals and provides a timed output to the microprocessor 36, as described more particularly below.

The general concept implemented by the ETS circuit is known. The probe interface circuit 48 generates hundreds of thousands of very fast pulses of 500 picoseconds or less rise time every second. The timing between pulses is tightly controlled. The reflected pulses are sampled at controlled intervals. The samples build a time multiplied “picture” of the reflected pulses. Since these pulses travel on the probe 24 at the speed of light, this picture represents approximately ten nanoseconds in real time for a five-foot probe. The probe interface circuit 48 converts the time to about seventy-one milliseconds. As is apparent, the exact time would depend on various factors, such as, for example, probe length. The largest signals have an amplitude on the order of twenty millivolts before amplification to the desired amplitude by common audio amplifiers. For a low power device, a threshold scheme is employed to give interrupts to the microprocessor 36 for select signals, namely, fiducial, reference target, level and other targets of interest, and end of probe, as described below. The microprocessor 36 converts these timed interrupts into distance. With the probe length entered through the display/push button interface 40, or some other interface, the microprocessor 36 can calculate the level by subtracting from the probe length the difference between the fiducial and level distances. Changes in measured location of the reference target can be used for velocity compensation, as necessary or desired.

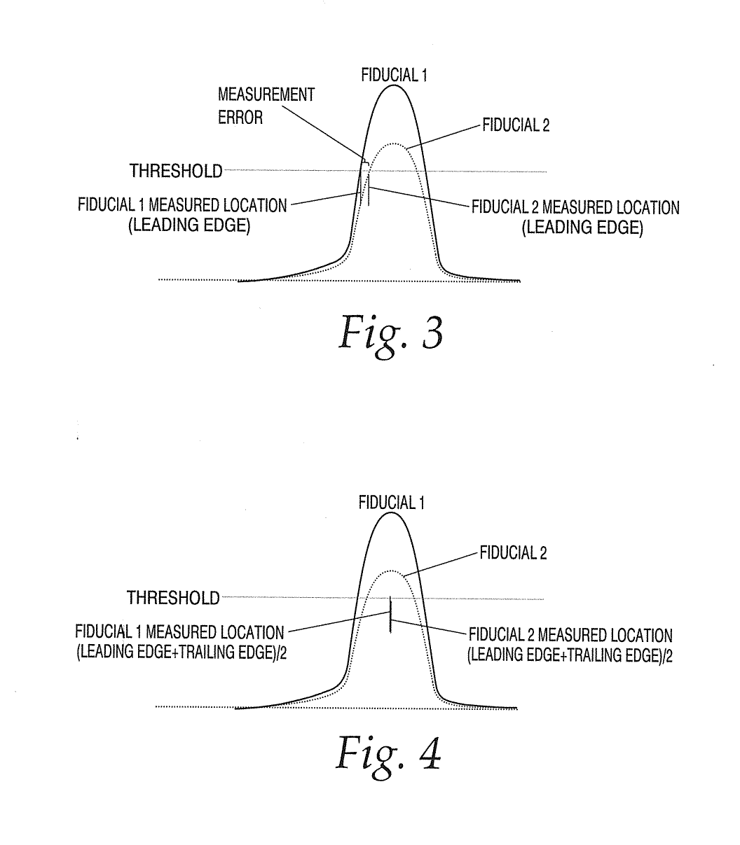

As discussed, in order to perform level measurement or more generally distance measurement, using reflected echo signals, it is necessary to determine the precise position of the fiducial. This is conventionally done using single edge fiducial detection, illustrated in FIG. 3. With single edge fiducial detection, using a fixed threshold voltage, the measured location can change depending on the signal amplitude. This is because the edges of the fiducial signal are sloped. Alternatively, the controller 30 may detect the leading edge and trailing edge of the fiducial pulse, see FIG. 4. The fiducial location is determined by averaging the leading and trailing edges.

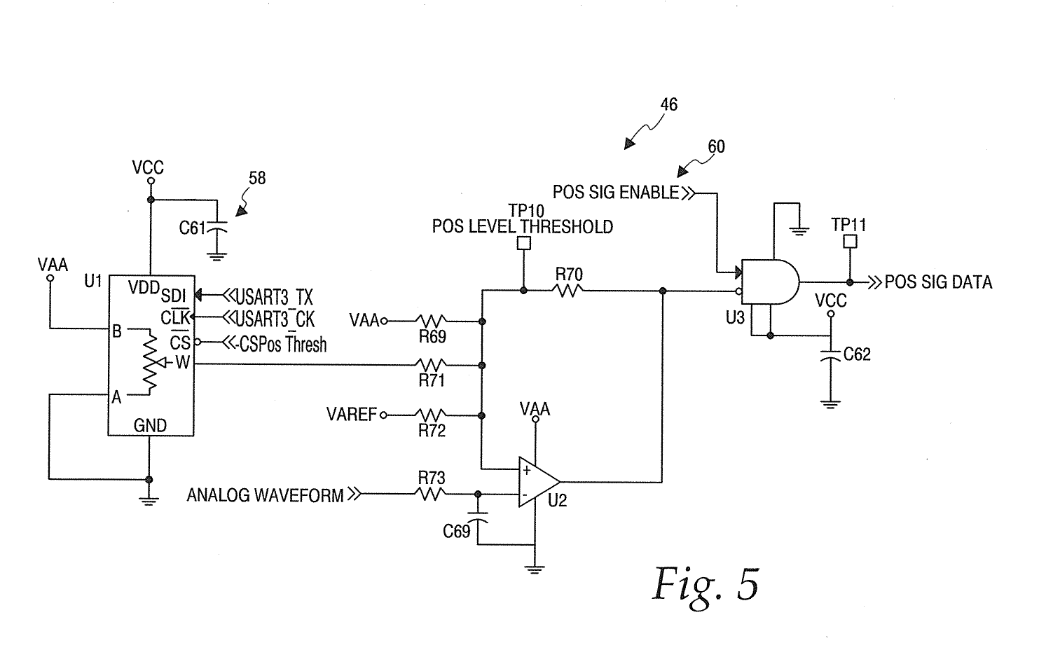

Referring to FIG. 5, a portion of the signal processing circuit 46 is illustrated which is operable to acquire the leading edge and trailing edge times of the fiducial echo signal. The signal processing circuit 46 comprises a programmable threshold circuit 58 and a positive signal detector circuit 60. Although not shown, a negative signal detector circuit is used to detect negative polarity reflected echoes. The threshold circuit 58 uses a digital potentiometer U1. The digital potentiometer U1 may be, for example, a type AD5160 256 position digital potentiometer. The digital potentiometer U1 receives a serial data input from the microprocessor 36 to generate a select threshold value output at a terminal W to the positive signal detector circuit 60. Thus, the select threshold value is determined by the microprocessor 36, as discussed below.

The positive signal detector circuit 60 includes a comparator U2. The non-inverted input receives the threshold value from the digital potentiometer U1. The inverted input receives an analog waveform, comprising the analog receive signal representative of the reflected echoes, from the probe interface circuit 48. The output of the comparator U2 is provided to a gate circuit U3 which also receives a positive signal enable signal from the microprocessor 36. The output of the gate U3 comprises positive signal data output to the microprocessor 36. Particularly, the positive signal value is high if the gate U3 is enabled and if the pulse echo has a signal level greater than the select threshold value.

More particularly, the signal processing circuit 46 uses the positive signal detector circuit 60 along with the programmable threshold circuit 58 to acquire the leading and trailing edges of the fiducial signal which are output to the microprocessor 36. The microprocessor 36 functions as a timer to accurately capture the times of the leading and trailing edges of the fiducial where the fiducial rises above and falls below the associated positive signal threshold.

The signal processing circuit 46 initiates five scans per second. The first scan in a one second cycle is a fiducial scan used to determine location of the fiducial. The remaining four scans comprise measurement scans which can be used to acquire the target, upper level, interface and/or the end of the probe 24. As is apparent, the particular type of scans will depend upon the configuration of the device. Only one fiducial scan is performed every second as the fiducial is a relatively slow moving waveform feature.

The fiducial scan acquires the positive fiducial using the positive signal detector circuit 60. The fiducial scan captures both the leading and trailing edges of the fiducial pulse, as discussed. This minimizes apparent fiducial shift that occurs on a leading edge fiducial capture only when fiducial amplitude changes. The logic of the scan is such that only the leading edge signal data interrupt is enabled until the leading edge of the fiducial is captured. At that point, the leading edge interrupt is disabled and the falling edge interrupt is enabled to find the trailing edge of the fiducial. The positive signal enable, see FIG. 5, is set at the end of a fiducial dead band in order to gate around positive-going excitation pulse artifacts that present themselves just before the fiducial when the integral high frequency cable is used. The positive signal enable is cleared upon acquisition of the fiducial's training edge. The entire fiducial is not captured, then the positive signal enable will be cleared at the end of the ramp. The fiducial scan will utilize a fiducial gain and fixed fiducial threshold.

The microprocessor 36 is programmed to set the positive signal threshold value to the digital potentiometer U1 specific to fiducial acquisition. Programming in the microprocessor 36 configures a timer function to capture the leading edge of the fiducial signal. Particularly, the hardware positive signal data channel enable is set just before a “fiducial window”. The fiducial window is a time region where the microprocessor 36 expects to see a valid fiducial signal. When the leading edge of the fiducial echo crosses the threshold, the comparator U2 triggers an interrupt routine to save the time in the microprocessor 36. The microprocessor timer is then reconfigured to capture the trailing edge of the fiducial. Particularly, when the trailing edge of the fiducial crosses the threshold, the comparator U2 triggers the microprocessor timer that captures the trailing edge time and triggers an interrupt service routine to save the time. These time values are measured in ticks, as is known. The associated microprocessor timer is disabled and the hardware positive signal data channel enable is cleared. The microprocessor 36 then calculates the fiducial ticks as the average of the leading and trailing edge ticks that were acquired. If the fiducial signal is not in the fiducial window, as expected, a diagnostic is activated indicating “no fiducial”.

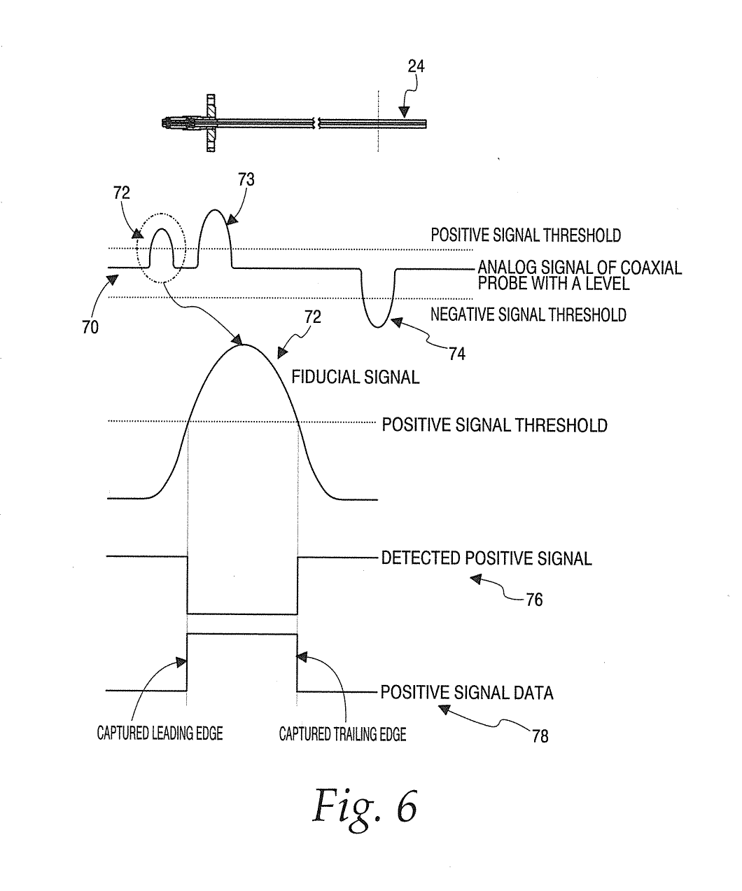

This operation is generally illustrated in FIG. 6 which shows the probe 24 aligned with an exemplary analog receive signal 70 representative of the reflected echoes. The analog receive signal 70 includes a positive fiducial echo 72 at the high frequency connector location, a positive target echo 73 at a steam reference target location and a negative level echo 74 at the liquid level surface. As shown, the microprocessor 36 uses a positive signal threshold for measuring positive polarity pulses and a negative signal threshold for measuring negative polarity pulses. It is well known that the circuitry can be designed such that the analog receive signal can be inverted. In that case, the fiducial echo pulse would be negative, requiring a negative signal threshold, and the level echo would be positive, requiring a positive signal threshold.

The analog waveform for the fiducial echo 72 is shown in expanded form alongside the positive signal threshold generated by the microprocessor 36. The detected positive signal output from the comparator U2 is shown at 76 which is converted to positive signal data 78, representing the output of the gate U3, with the curve 78. The signal 78 is used by the microprocessor 36 to determine the leading edge and trailing edge, as shown.

A TimeFlight task implemented in the microprocessor 36 utilizes an Echo Processing module function to gather waveform amplitude information. The amplitude information is in what are called Native (voltage) Units which are essentially 8-bit ADC counts [0.255] referenced to 2800 mV. These are the internal (˜native) units used for internal processing associated with comparator thresholds and signal amplitudes. Once every second, the TimeFlight task gathers amplitudes for the Fiducial, Steam Target, Upper Level, Interface Level, and End-of-Probe features and provides them to a Primary Measured Values (PMV) task. Ultimately, these values are made available to the user and external communications interfaces. This data is also utilized by the TimeFlight, task itself, for scan post processing (comparator threshold calculations, etc.) and diagnostic evaluation (amplitude-related diagnostics like Low Echo Strength).

The TimeFlight task implements several diagnostic indicators. A description of their functionality is given below.

No Probe

The no probe diagnostic determines if the amplitude of what appears to be the fiducial is greater than, for example, 194 native units (or 70 Echo Strength units). An amplitude of such magnitude usually indicates that the fiducial has essentially been replaced by a larger positive pulse that is caused by an open circuit at the probe connector. In other words, it is an indication that a probe is not connected.

In the illustrated embodiment, the fiducial is located physically close to the high frequency electrical connector. Thus, the controller 30 can monitor during the fiducial detection window for a significant increase in amplitude that indicates the high impedance open of a missing or unconnected probe. In fact, the pulse caused by the disconnected probe being so close to the fiducial location and being so strong in amplitude; it essentially overshadows the fiducial pulse. This avoids the necessity of monitoring elsewhere for the no probe condition.

No Fiducial

The no fiducial diagnostic determines if the fiducial was not acquired. This occurs if the median fiducial tick value is outside of the expected exemplary range, for example, [1125.1525], or the fiducial amplitude is below, for example, 137 native units (20 Echo Strength units). Such conditions are an indication that the fiducial is not present or not at the expected location or amplitude. However, it should be noted that such conditions can also occur if the transmitter is not properly calibrated or is not properly connected to a probe.

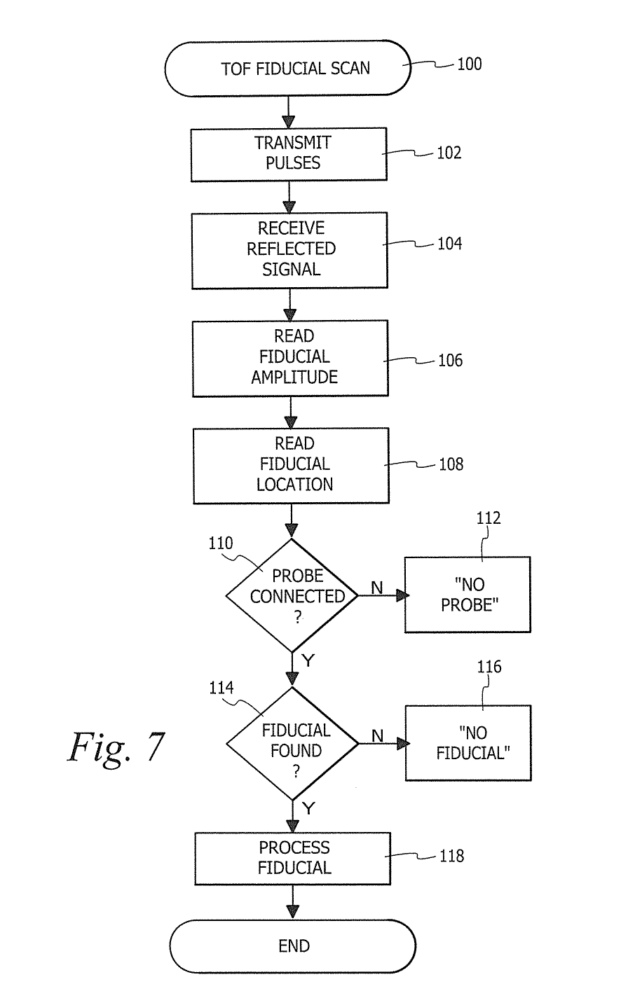

FIG. 7 illustrates a TimeFlight fiducial scan routine implemented in the microprocessor 36, see FIG. 2, using the data obtained from the signal processing circuit 46 discussed above. This routine begins at a node 100. A block 102 transmits the ETS pulses on the probe 24. The reflected signal is received at a block 104. A block 106 reads the fiducial amplitude for the fiducial in the measured native units, discussed above. The fiducial location is read at a block 108. A decision block 110 then determines if the probe is connected. In the illustrated embodiment of the invention, this determination is based on the amplitude of what appears to be the fiducial being greater than 194 native units. If so, then a no probe indication is made at a block 112.

If the probe 24 is connected, then a decision block 114 determines whether or not the fiducial has been found. If not, then a no fiducial diagnostic indication is given at a block 116. The presence of this diagnostic indicates that the fiducial was not acquired at the expected time or if the fiducial amplitude is below the expected amplitude. If the fiducial has been found, then the fiducial is processed in the normal manner at the block 118 and the routine ends. Subsequent scans each second will be for measurement scans, as discussed above.

As will, be apparent, other values for amplitude and fiducial location can be used as the disclosed values mentioned herein are just examples.

Thus, the diagnostic routine described herein is useful for determining if there is any error in the fiducial, such as the fiducial being undetectable, or at an unexpected location.

As is apparent, the functionality of the threshold circuit 58 and the detector circuit 60, as well as other analog circuits, could be implemented in the microprocessor 36, or any combination thereof. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. Other embodiments may be within the scope of the following claims.

1. A process measurement instrument including a fiducial and adapted for detection of the fiducial comprising:
an interface circuit comprising a drive circuit for transmitting a pulse signal at the fiducial and at a target of interest and a receive circuit receiving reflected echoes of the pulse signal and developing an analog receive signal representative of the reflected echoes;
a signal processing circuit operatively coupled to the interface circuit for receiving the analog receive signal and determining characteristics of reflected echoes for the fiducial and the target of interest; and
a controller operatively coupled to the signal processing circuit and including a diagnostic routine responsive to the characteristics of the reflected echo for the fiducial and determining if a fiducial error condition exists.

2. The process measurement instrument of claim 1 wherein the interface circuit is operatively coupled to a probe defining a transmission line.

3. The process measurement instrument of claim 1 wherein the interface circuit is operatively coupled to a probe defining an antenna.

4. The process measurement instrument of claim 1 wherein the controller comprises a programmed processor.

5. The process measurement instrument of claim 1 wherein the diagnostic routine is operable to determine if location of the reflected echo for the fiducial is outside of an expected range.

6. The process measurement instrument of claim 5 wherein the location of the reflected echo for the fiducial is determined by averaging leading and trailing edges of the reflected echo for the fiducial.

7. The process measurement instrument of claim 1 wherein the controller determines if the reflected echo for the fiducial is not received in a receive window and responsive thereto indicates a no fiducial diagnostic.

8. The process measurement instrument of claim 1 wherein the diagnostic routine is operable to determine if amplitude of the reflected echo for the fiducial is outside of an expected range.

9. The process measurement instrument of claim 8 wherein the diagnostic routine is operable to determine if amplitude of the reflected echo for the fiducial is above an expected range to indicate that a probe is disconnected.

10. The process measurement instrument of claim 1 wherein the controller is responsive a determination that a fiducial error does not exist to determine a time value between the reflected echo for the fiducial and the reflected echo for the target of interest to determine a distance value.

11. A guided wave radar level measurement comprising:
a probe for extending into a process vessel, the probe including a fiducial;
an interface circuit electrically connected to the probe and comprising a drive circuit for transmitting a pulse signal at the fiducial and at a target of interest and a receive circuit receiving reflected echoes of the pulse signal and developing an analog receive signal representative of the reflected echoes;
a signal processing circuit operatively coupled to the interface circuit for receiving the analog receive signal and determining characteristics of reflected echoes for the fiducial and the target of interest; and
a controller operatively coupled to the signal processing circuit and including a diagnostic routine responsive to the characteristics of the reflected echo for the fiducial and determining if a fiducial error condition exists.

12. The guided wave radar level measurement instrument of claim 11 wherein the fiducial is located proximate an electrical connector connecting the probe to the interface circuit.

13. The guided wave radar level measurement instrument of claim 12 wherein the fiducial creates an impedance mismatch at the electrical connector.

14. The guided wave radar level measurement instrument of claim 11 wherein the controller comprises a programmed processor.

15. The guided wave radar level measurement instrument of claim 11 wherein the diagnostic routine is operable to determine if location of the reflected echo for the fiducial is outside of an expected range.

16. The guided wave radar level measurement instrument of claim 15 wherein the location of the reflected echo for the fiducial is determined by averaging leading and trailing edges of the reflected echo for the fiducial.

17. The guided wave radar level measurement instrument of claim 11 wherein the controller determines if the reflected echo for the fiducial is not received in a receive window and responsive thereto indicates a no fiducial diagnostic.

18. The guided wave radar level measurement instrument of claim 11 wherein the diagnostic routine is operable to determine if amplitude of the reflected echo for the fiducial is outside of an expected range.

19. The guided wave radar level measurement instrument of claim 18 wherein the diagnostic routine is operable to determine if amplitude of the reflected echo for the fiducial is above an expected range to indicate that a probe is disconnected.

20. The guided wave radar level measurement instrument of claim 11 wherein the controller is responsive a determination that a fiducial error does not exist to determine a time value between the reflected echo for the fiducial and the reflected echo for the target of interest to determine a distance value.
